(19) United States
(12) Patent Application Publication
(10) Pub. No.: US 2014/0104137 A1
(43) Pub. Date: Apr. 17, 2014

(54) SYSTEMS AND METHODS FOR INDIRECTLY ASSOCIATING LOGICAL AND PHYSICAL DISPLAY CONTENT

(71) Applicant: Jeff Brown, Mountain View, CA (US)

(72) Inventor: Jeff Brown, Mountain View, CA (US)

(73) Assignee: GOOGLE INC., Mountain View, CA (US)

(21) Appl. No.: 13/757,545

(22) Filed: Feb. 1, 2013

Related U.S. Application Data
(60) Provisional application No. 61/714,738, filed on Oct. 16, 2012.
(60) Provisional application No. 61/719,792, filed on Oct. 29, 2012.

(51) Int. Cl. G09G 3/00

(52) U.S. Cl. CPC G09G 3/00
USPC 345/1.1

(57) ABSTRACT

Systems and methods include utilizing a layer stack to indirectly associate logical and physical display content. A layer stack may decouple content from content presentation details at a physical display, facilitating the implementation of mirroring, spanning, and other multiple-display modes across non-contiguous display devices with disparate resolutions, densities, and other characteristics, while maintaining native device configuration settings. In one implementation, a layer stack may be a collection of surfaces. The layer stack may be associated with a first logical display having a first resolution. A region containing parts of one or more surfaces, at a first position of the layer stack and corresponding to the first resolution of the first logical display, may be rendered and output, based on a display projection, to a first physical display. Further implementations may use combinations of additional logical displays, physical displays, or layer stacks to implement various multiple-display modes.

### CROSS-REFERENCE TO RELATED APPLICATIONS

This application claims priority and the benefit under 35 U.S.C. §119(e) of U.S. Provisional Patent Application No. 61/714,738, filed 16 Oct. 2012, and of U.S. Provisional Patent Application No. 61/719,792, filed 29 Oct. 2012, all of which the entire contents and substance are hereby incorporated by reference as if fully set forth below.

### BACKGROUND

Many modern computing devices can support more than one display that may be used independently or in tandem to display content associated with various services or applications. Multiple-display technologies are also becoming common on mobile devices (e.g., smartphones and tablets). For example, some mobile devices feature two or more displays integrated into the same device. Also, some mobile devices can display content on one or more external display devices through a direct link such as HDMI, MHL, USB, etc., or wirelessly using a protocol like Miracast or Wifi Display. In these scenarios, the displays may be in heterogeneous locations or orientations. Moreover, the display may have different resolutions, densities, and other disparate characteristics that complicate displaying appropriately formatted content on and across the displays. For example, in one scenario, a smartphone may simultaneously display content on an integrated four-inch display in portrait mode, and may also display related content on a wall-mounted LCD TV in a landscape orientation.

Conventional multiple-display technologies do not dynamically display formatted content on non-contiguous displays with disparate characteristics. This is due in part because conventional technologies directly associate logical and physical display content, effectively constraining the logical content according to characteristics of a destination physical display. As a result, mirroring content across two displays with different native resolutions, for example, can require changing the resolution of one of the displays to a non-pixel-perfect resolution, or only displaying a portion of the mirrored content on one of the displays. Moreover, some conventional technologies span content across multiple displays by stretching a virtual workspace across displays aligned side by side. In these configurations, the displays are required to be contiguous and of a same resolution or color depth. Also because of the direct association between logical and physical display content, some conventional multiple-display technologies are unable to respond fluidly to the addition or removal of displays from a multiple-display setup without reconfiguring one or more display devices or hardware.

### SUMMARY

Some or all of the above needs may be addressed by certain implementations of the disclosed technology. Certain implementations may include using a layer stack to indirectly associate logical and physical display content. According to an example implementation, a method is provided. The method may include associating a first layer stack for grouping one or more surfaces with a first logical display having a first logical resolution. The method may also include associating a first application having a first surface with the first logical display and grouping the first surface on the first layer stack. The method may further include applying a first display projection to a first region of the first layer stack, the first region corresponding to the first logical resolution of the first logical display and including at least part of the first surface. The method may yet further include, rendering the first region and outputting at least part of the rendered first region for display at a first display device.

Other implementations, features, and aspects of the disclosed technology are described in detail herein and are considered a part of the claimed disclosed technology. Other implementations, features, and aspects may be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 depicts an illustration of a computing device, according to an example implementation.

FIG. 2 depicts an illustration of a block diagram of the system with multiple displays in a mirroring mode, according to an example implementation.

FIG. 3 depicts an illustration of a block diagram of the system with multiple displays in an extended desktop mode, according to an example implementation.

FIG. 4 depicts an illustration of a block diagram of the system with a single display presenting two workspaces, according to an example implementation.

FIG. 5 depicts an illustration of a flow diagram of the method, according to an example implementation.

FIG. 6 depicts an illustrative block diagram of a mobile computing device system architecture, according to an example implementation.

### DETAILED DESCRIPTION

To facilitate an understanding of the principles and features of implementations of the disclosed technology, various example implementations are explained below. Although example implementations of the disclosed technology are explained in detail, other implementations are contemplated. Further, in describing the example implementations, specific terminology will be resorted to for the sake of clarity. It is not intended that the disclosed technology be limited in scope to the details of construction and arrangement of components set forth in the following description or illustrated in the drawings. Rather, the disclosed technology is capable of other implementations and of being practiced or carried out in various ways.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. Relational terms such as “first” and “second,” and the like may be used solely to distinguish one entity or action from another entity or action without necessarily requiring or implying any actual such relationship or order between such entities or actions. The term “or” is intended to mean an inclusive “or.” Further, the terms “a,” “an,” and “the” are intended to mean one or more unless specified otherwise or clear from the context to be directed to a singular form. The term “include” and its various forms are intended to mean including but not limited to.

The term “content” refers to information or data that may be presented on one or more displays associated with a computing device. By way of example, content may include any one or more of text, images, videos, audio files, executables, links to executables, UI elements, windows, workspaces, desktops, and the like. In an example implementation, content may be provided by one or more services and/or applications executing on, requested by, or transmitted to the computing device.

Various implementations of the disclosed technology relate to indirectly associating logical and physical display content. Implementations of the disclosed technology also relate to outputting content to one or more displays and, more particularly, systems and methods for outputting content to multiple non-contiguous displays with disparate characteristics.

Presenting content on multiple displays can be a challenging task. In an example scenario, a mobile device with a built-in, or integrated, display may be in communication with one or more secondary display devices. The secondary display devices may be directly connected to the mobile device by via HDMI, MHL, USB, etc., or coupled wirelessly using a protocol such as Miracast or Wifi Display. To complicate matters, these display devices may have displays with different resolutions and densities. Also, one or more of the display devices may be disconnected or decoupled at any time, either intentionally, such as by unplugging a cable, or accidentally, such as through the unintended loss of wireless service.

Moreover, in a sample use case, an application might present content on the integrated display that is also mirrored onto a secondary display device. In another use case, an application might provide some content on the integrated display and different content on the secondary display device. A third use case could include switching between the two aforementioned use cases. Accordingly, robust systems and methods are needed for dynamically displaying content on multiple non-contiguous displays with disparate characteristics. To support these systems and methods, certain implementations of the disclosed technology utilize a novel concept herein referred to as a “layer stack.”

Conventional multiple-display systems comprise one or more logical displays and physical displays. A logical display may represent a region of screen real-estate (e.g., a workspace) where an application may present content. A logical display may have a resolution, density, or other properties such as a descriptive name, a unique identifier, etc.

A physical display may represent a real screen or physical display area, for example, the screen of a smartphone, LCD monitor, etc., or the display area of a projector. A physical display may have a resolution, defined as width and height in pixels, a density, defined as pixels per inch as perceived from a typical viewing distance, or various other properties such as a native resolution, dot pitch, bit depth, etc.

Logical and physical displays may be combined to provide various display functionality. For example, a “spanning” or “extended-desktop” mode may be modeled by providing a logical display that spans multiple physical displays. In another example, an independent-multiple-display mode may be modeled by providing multiple logical displays, at least some of which are presented on one or more physical displays.

The disclosed technology connects these concepts by using a layer stack to indirectly associate logical and physical display content. In providing a layer of indirection, a layer stack may decouple logical content from presentational details at a physical display, facilitating the implementation of mirroring, spanning, and other multiple-display modes. Because the logical content is divorced from any particular set of presentational constraints (e.g., resolution, density, bit depth), layer stacks may enable fluid formatting and display of content across non-contiguous display devices with disparate characteristics while maintaining native device configuration settings.

Referring now to the figures, in which like reference numerals represent like parts throughout the views, various implementations of the disclosed technology will be described in detail.

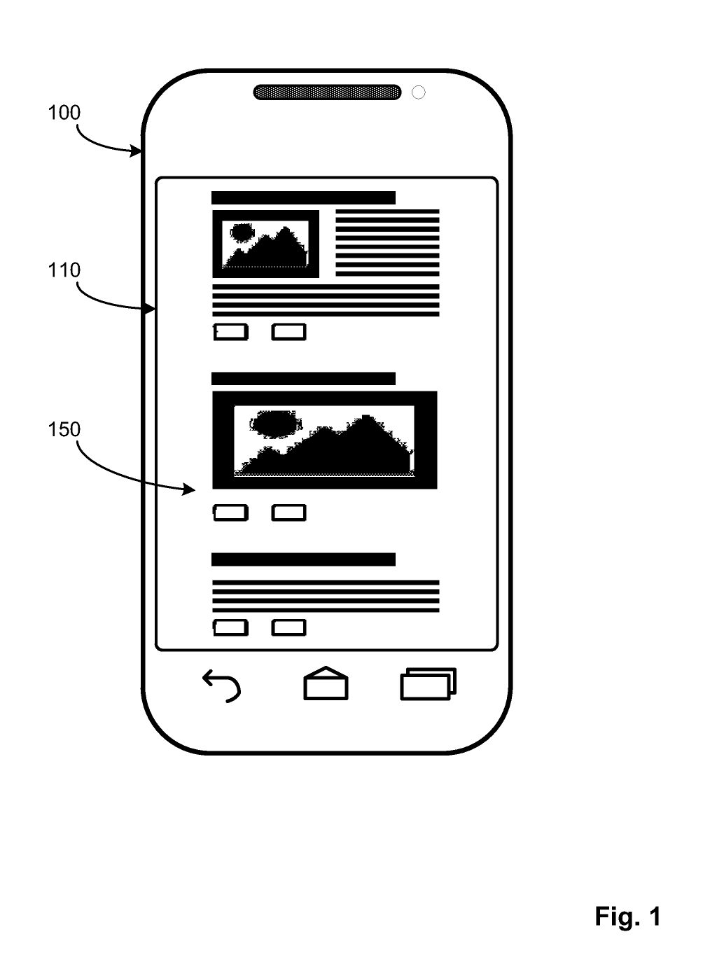

FIG. 1 depicts an example illustration of a computing device 100. As shown in FIG. 1, the computing device 100 may be a mobile computing device, for example, a smartphone or a tablet. The computing device may have a built-in or integrated first physical display 110 for displaying content 150. The display 150 of the mobile device may be a touch-sensitive or presence-sensitive display for receiving user input from a stylus, fingertip, or other means of gesture input. In some implementations of the disclosed technology, the computing device may be a non-mobile computing device, for example, a personal computer, with an internal or external first display operatively connected.

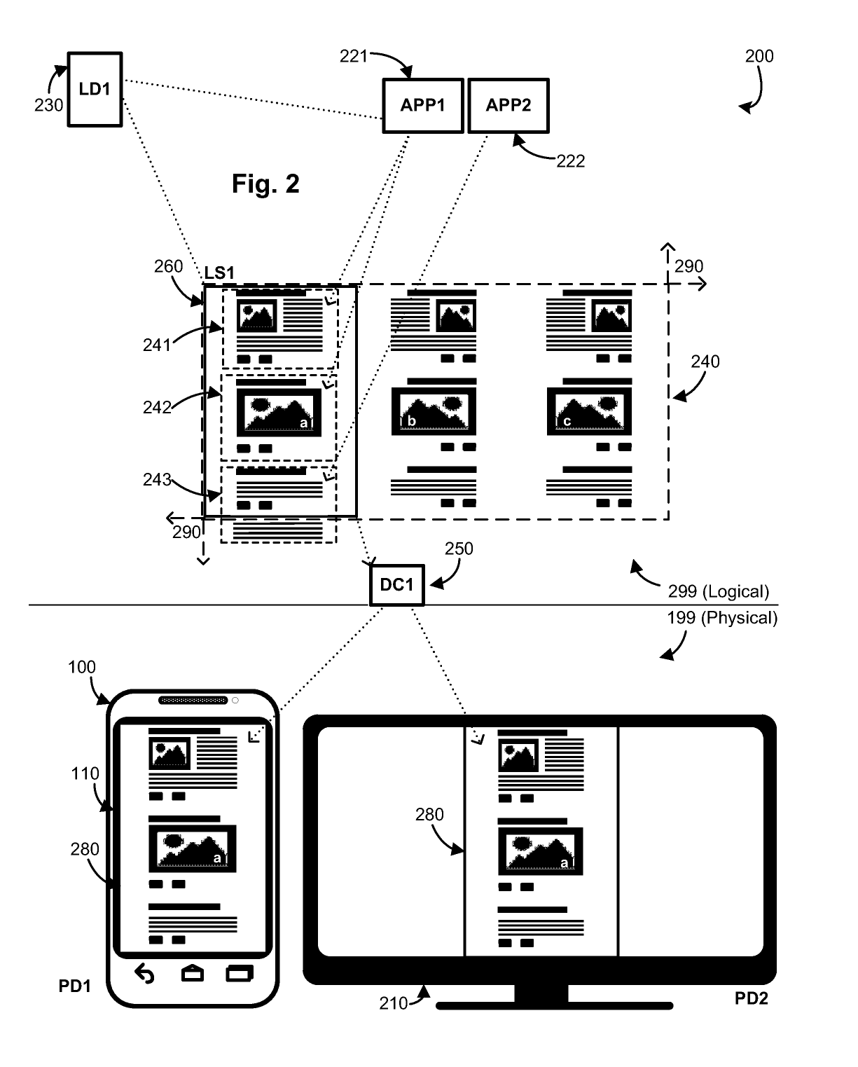

FIG. 2 depicts an example illustration of a multiple-display system 200. As shown in FIG. 2, in certain example implementations, the system may include one or more physical 199 components including a first computing device 100. In some implementations, one or more logical 299 components of the system can reside on or be executed by the first computing device 100 and/or one or more other computing devices. The system may also include two or more physical displays, including a first physical display 110, and a second physical display 210. Although the examples herein are described in the context of a first and second physical display, it will be understood by one of skill in the art that implementations of the disclosed technology are generally applicable to multiple-display systems with any number of displays.

The first and second physical displays 110, 210 may be operatively coupled to the first computing device 100. In some implementations, a physical display may be part of a display device connected to the computing device through a direct link such as HDMI, MHL, USB, etc., or coupled wirelessly using a protocol like Miracast or Wifi Display.

One or more applications 221, 222 may be associated with the computing device 100. In certain example implementations, an application 221, 222 may be executed by one or more processors 602 on the first computing device 100. In some implementations, an application may be executed remote from the first computing device.

In certain example implementations, the system may include a first logical display 230 and a first layer stack 240 associated with the first logical display. A layer stack may group one or more layers, or “surfaces,” 241, 242, 243 containing pixels. In an example implementation, a layer stack may group surfaces into a Z-ordered stack. A surface may be a container for some content 150, such as a display area associated with an application 221, 222. In an example implementation, a surface may represent a window in a GUI environment. In another implementation, a surface, may have X, Y, and Z (depth) position properties and also width and height properties.

Although the layer stack 240 in FIG. 2 may appear to be a bounded plane, in certain example implementations, a layer stack may be considered dimensionless in that it lacks a resolution, density, or other presentational constraints. Thus, in some implementations, a logical display 230 may be responsible for creating surfaces 241, 242, 243 on an associated layer stack that are of an appropriate size and scaled to an appropriate density (e.g., appropriate font size) for the logical display. The layer stack however, may be agnostic to these presentation details, and merely group surfaces.

Thus, as shown in FIG. 2 by the arrows 290, a layer stack 240 may figuratively “extend” as necessary to accommodate associated surfaces 241, 242, 243. Accordingly, in an example implementation, a surface may be positioned anywhere within a layer stack. Also, two surfaces need not necessarily overlap, although they may.

As shown in FIG. 2, in certain example implementations, a logical display 230 may be associated with exactly one layer stack 240. However, this relationship does not have to be one-to-one. In some implementations, two or more logical displays can be associated with the same layer stack.

In certain example implementations, there may be an arbitrary number of layer stacks or an arbitrary number of surfaces 241, 242, 243. Layer stacks may be independent of one another or linked. In one implementation, a surface may belong to more than one layer stack. A surface may also be associated with one or more transformation matrices, alpha, and other properties of interest to a display compositor 250.

To display content on a display, a physical display device 110, 210 may be directed to present a particular part or region of a layer stack 240 based on a given display projection. Moreover, in some implementations, this part of a layer stack may coincide with a logical frame or viewport 260 based on the characteristics of an associated logical display 230. As shown in FIG. 2, surfaces on a layer stack may fit 241, 242 or may not fit 243 completely within the boundaries of a logical viewport. In one implementation, areas of a surface outside a logical viewport may not be presented at a physical display.

In certain example implementations, a display combinator 250 may compose or prepare part of a layer stack 240 for presentation at a physical display 110, 210. In some implementations, composing may include rendering surfaces 241, 242, 243 within a part or region of the layer stack coinciding with the bounds of a logical viewport 260. In some implementations, rendering Z-ordered surfaces on a layer stack within a logical viewport may result in a “flattening” of the surfaces for presentation at a physical display.

In certain example implementations, the dimensions of a logical viewport 260 may correspond to or match a logical display 230 associated with the layer stack 240 the logical viewport is applied to. However, the dimensions of the logical viewport may not match a destination physical display 110, 210. To ensure rendered content is appropriately formatted for a destination physical display, a display projection may be used to scale, or otherwise transform (e.g., by translation and/or rotation) the content to conform to desired display dimensions, or other parameters. For example, logical content sampled from a logical viewport of first resolution may be scaled up or down to fit the display area of a physical display having a second larger or smaller resolution. In another example implementation, a display projection may be associated with a transformation matrix, set clip bounds, adjust color correction curves, apply visual effects, etc.

In some implementations, a display projection may be applied during composition by a display compositor 250. In another example implementation, a display projection may be applied before composition. In yet another example implementation, a display projection may be applied after composition.

Content may not necessarily be scaled to fit the entire screen area of a physical display 110, 210. In some implementations, a display projection may maintain the aspect ratio of logical content. If the logical content is of a different aspect ratio than a destination physical display the physical content may not cover the entire display area of the physical display. In these instances a letterbox, pillarbox, or windowbox effect may be created. For example, in FIG. 2, the same content is presented across a first physical display 110 (e.g., smartphone) in a portrait orientation and a second physical display 210 (e.g., LCD TV) in a landscape orientation. In this example, the content retains the same orientation and aspect ratio across both physical displays, resulting in a pillarbox effect around the content displayed on the second physical display.

In certain example implementations, a display projection may be content agnostic, or based on a fixed rule for computing the display projection, for example, “always scale content to fit.” In some implementations, a variable display projection may be utilized to apply more elaborate effects such as 3D transformation, blends, color space conversions, etc.

In certain example implementations, content may be scaled to fit a particular part or region of a physical display 110, 210 herein referred to as a physical frame 280. In an example implementation, a portion of content may be clipped, and the clipped content scaled to fit a particular physical frame. If the physical frame has a higher resolution than the clipped portion, this can result in a magnified, or “zoomed-in” view of the clipped content.

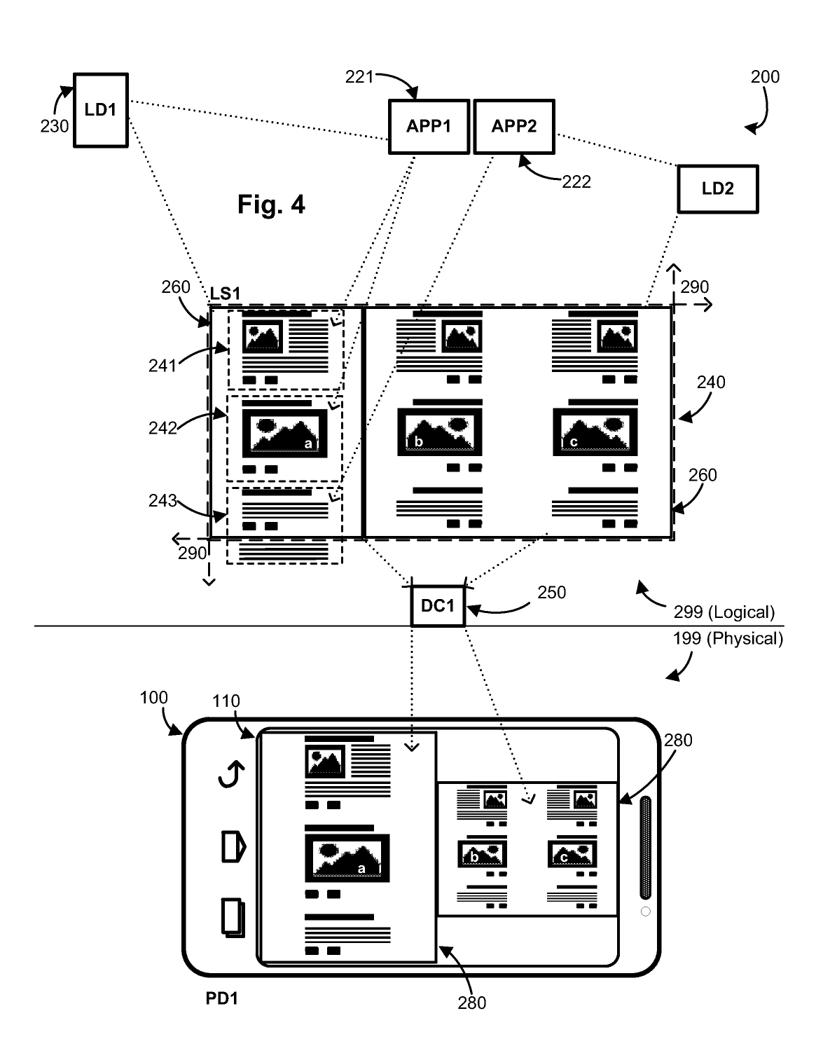

In some implementations, a physical frame 280 may include any part of the display area of a physical display 110, 210, and a physical display may have more than one physical frame. In this way, mirroring and spanning of content may occur on a single physical display. For example, a single physical display could be divided into two adjacent physical frames. Each physical frame could display content associated with a different layer stack 240 or logical display 230, or could even display content from the same layer stack or logical display, as shown in FIG. 4.

In one sample use case, a first logical display L1 is provided having a resolution of 1280×720 pixels (px) and density of 240 dots per inch (dpi). Two physical displays are also provided, P1, having a resolution of 1280×720 px and density of 240 dpi, and P2, having a resolution of 1920×1080 px and density of 300 dpi. The system may be configured such that physical displays P1 and P2 both display content associated with logical display L1. If P0 is the default screen, then P1 could be considered to be mirroring and scaling the content at P0.

To achieve mirroring, the logical display L1 is associated with layer stack LS1. On the layer stack are several layers that represent windows in a GUI environment. The layers have been arranged so that they all fit within the bounds (1280×720 px) of the logical display L1.

To show L1 on P1, the display projection of P1 is set so that it reads the part of LS1 in the logical viewport rectangle [0,0,1280,720] and presents it on the screen at the physical frame rectangle [0,0,1280,720].

To show L0 on P1, the display projection of P2 is set so that it reads the part of LS1 in the logical viewport rectangle [0,0,1280,720] and presents it on the screen at the physical frame rectangle [0,0,1920,1080]. Because the physical frame is bigger than the logical viewport the content will be scaled up for display.

In this sample use case, utilizing a layer stack enables the content to be mirrored for display by simply directing the first and second physical displays to show the same layer stack and scaling the logical content on the layer stack to fit each physical display as necessary.

In certain example implementations, other multiple-display modes and use cases may be modeled using various combinations of layer stacks 240, logical displays 230, and physical displays 110, 210. For example:

The disclosed technology may be used to implement spanning displays. In one example implementation, a first physical display may be directed to show part of a layer stack corresponding to a first part of a first logical viewport, and a second physical display may be directed to show part of the same layer stack corresponding to an adjacent or different part of the same logical viewport.

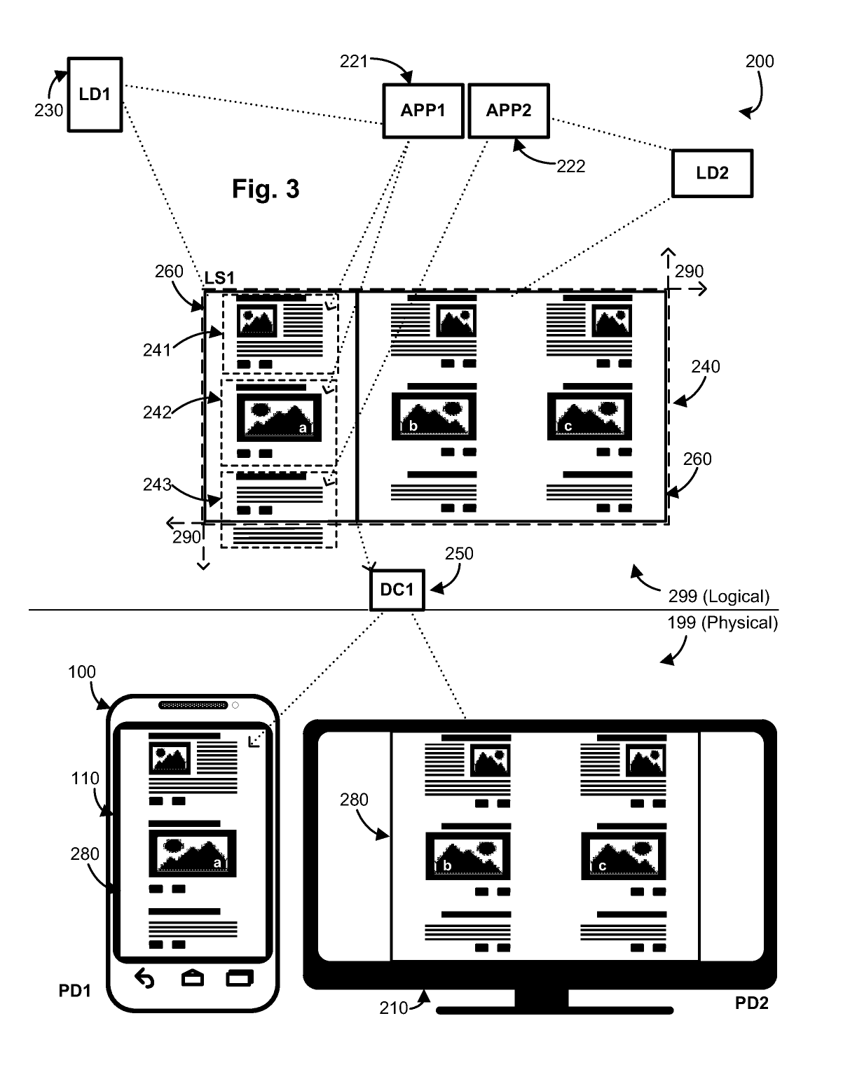

The disclosed technology may be used to implement extended displays. In one implementation, a first physical display may be directed to show a first part of layer stack corresponding to a first logical viewport associated with a logical first display, and a second physical display may be directed to show an adjacent or different part of the same layer stack corresponding to another logical viewport associated with a second logical display, as shown in FIG. 3.

The disclosed technology may be used to implement independent logical displays. In one implementation, a first physical display may be directed to show part of a first layer stack, and a second physical display may be directed show part of a different second layer stack.

Other possible configurations, including combinations of the previously described display modes, are within the scope of the disclosed technology and will be apparent to one of skill in the art.

Utilizing a layer stack to indirectly associate logical and physical display content enables certain example implementations to dynamically display content on and across multiple non-contiguous displays with disparate characteristics. Because content on a layer stack may be scaled to fit any part of the display area of a physical display, changing the resolution of a physical display to match the dimensions of the content is unnecessary. Thus, in some example implementations, fixed-pixel displays or physical display devices with a fixed raster (e.g., LCD and plasma displays) may operate at native resolutions without being required to interpolate display content (which involves complex signal processing and typically results in a loss of image quality); and without being required to display content on a reduced sub-region of a screen, making inefficient use of the display area. Even systems including physical display devices capable of changing display resolution (e.g., CRT displays) may benefit from avoiding the associated delay and viewing experience disruption.

Moreover, because example implementations of the disclosed technology make configuration changes at the display devices unnecessary, multiple-display systems may dynamically and fluidly switch between display modes and content formats. For example, in some implementations, mirroring and non-mirroring modes on display devices with different native resolutions may be activated and switched between by changing a display projection to present a particular layer stack on a display. Thus, the sudden addition or disconnection of a display device from the system no longer entails a viewing disruption while the pre-existing or remaining display devices are reconfigured.

In certain example implementations, a layer stack may be created that is not visible on any physical display. If the associated logical display becomes visible, the corresponding part of the hidden layer stack may be rendered and output to a physical display. In an example implementation, a hidden layer stack may become visible after some condition is met. In another example implementation, a visible layer stack may become hidden after a condition is met.

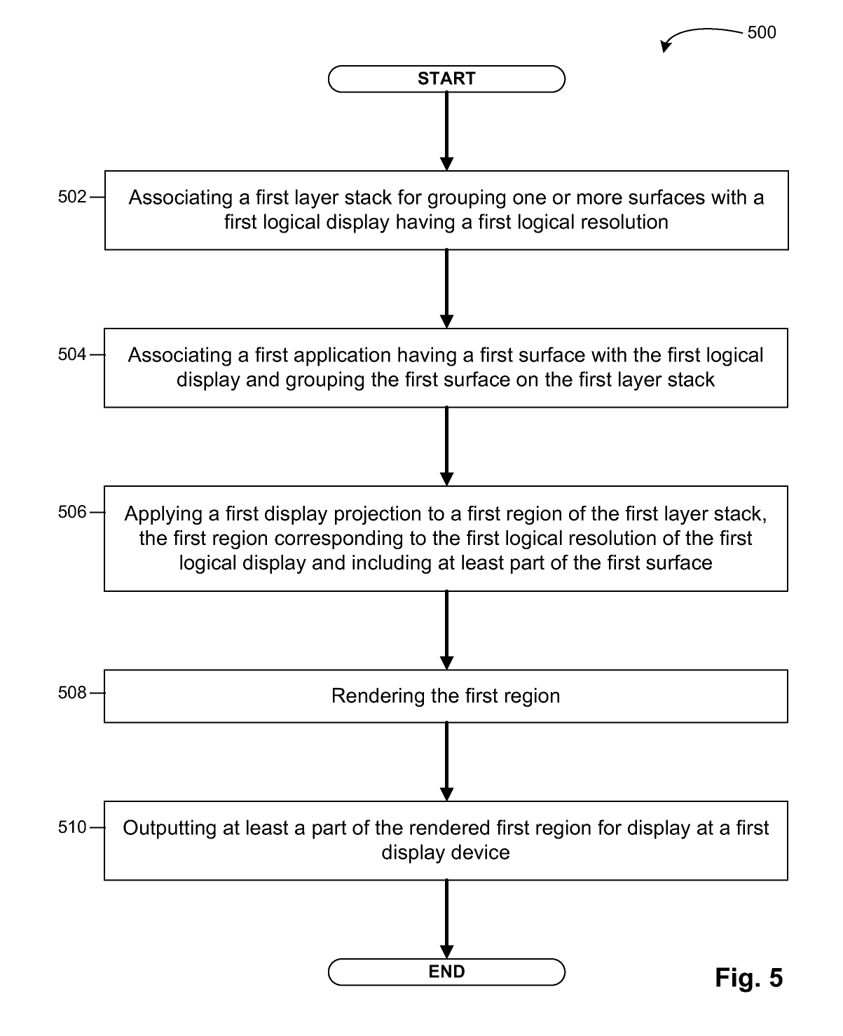

An example method 500 for indirectly linking logical and physical display content will now be described with reference to the flow diagram of FIG. 5. The method 500 starts in block 502, and according to an example implementation associating a first layer stack for grouping one or more surfaces with a first logical display having a first logical resolution. In block 504, the method 500 includes associating a first application having a first surface with the first logical display and grouping the first surface on the first layer stack. In block 506, the method 500 includes applying a first display projection to a first region of the first layer stack, the first region corresponding to the first logical resolution of the first logical display and including at least part of the first surface. In block 508, the method 500 includes rendering the first region. In block 510, the method 500 includes outputting at least part of the rendered first region for display at a first display device.

Various implementations of the disclosed technology may be embodied in non-transitory computer readable media for execution by a processor. An example implementation may be used in an application of a mobile computing device, such as a smartphone or tablet, but other computing devices, including non-portable computing devices, may also be used.

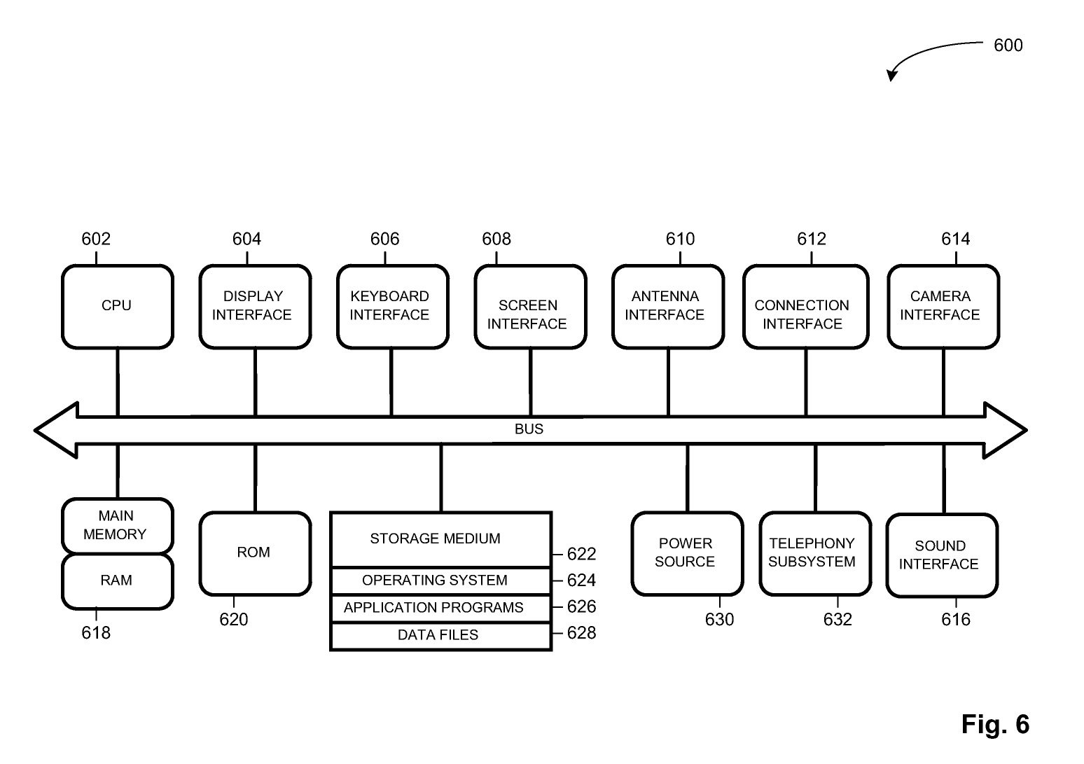

FIG. 6 depicts a block diagram of an illustrative computer system architecture 600 according to an example implementation. Certain aspects of FIG. 6 may be embodied in a computing device (for example, the mobile computing device 100 as shown in FIG. 1). It will be understood that the architecture 600 is provided for example purposes only and does not limit the scope of the various implementations of the communication systems and methods.

The architecture 600 of FIG. 6 includes a central processing unit (CPU) 602, where computer instructions are processed; a display interface 604 that acts as a communication interface and provides functions for rendering video, graphics, images, and texts on the display; a keyboard interface 606 that provides a communication interface to a keyboard; and a pointing device interface 608 that provides a communication interface to a pointing device, e.g., a touchscreen or presence-sensitive screen. Example implementations of the architecture 600 may include an antenna interface 610 that provides a communication interface to an antenna. Example implementations may include a connection interface 612. The connection interface may include one or more of a peripheral connection interface and network communication interface, providing a communication interface to an external device or network. In certain implementations, a camera interface 614 may be provided that acts as a communication interface and provides functions for capturing digital images from a camera. In certain implementations, a sound interface 616 may be provided as a communication interface for converting sound into electrical signals using a microphone and for converting electrical signals into sound using a speaker. According to example implementations, a random access memory (RAM) 618 may be provided, where computer instructions and data may be stored in a volatile memory device for processing by the CPU 602.

According to an example implementation, the architecture 600 may include a read-only memory (ROM) 620 where invariant low-level system code or data for basic system functions such as basic input and output (I/O), startup, or reception of keystrokes from a keyboard are stored in a non-volatile memory device. According to an example implementation, the architecture 600 may include a storage medium 622 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 624, application programs 626 (including, for example, a web browser application, a widget or gadget engine, and or other applications, as necessary) and data files 628 are stored. According to an example implementation, the architecture 600 may include a power source 630 that provides an appropriate alternating current (AC) or direct current (DC) to power components. According to an example implementation, the architecture 600 may include a telephony subsystem 632 that allows the device 600 to transmit and receive sound over a telephone network. The constituent devices and the CPU 602 may communicate with each other over a bus 634.

In accordance with an example implementation, the CPU 602 may have appropriate structure to be a computer processor. In one arrangement, the computer CPU 602 may include more than one processing unit. The RAM 618 may interface with the computer bus 634 to provide quick RAM storage to the CPU 602 during the execution of computing programs such as the operating system application programs, and device drivers. More specifically, the CPU 602 may load computer-executable process steps from the storage medium 622 or other media into a field of the RAM 618 in order to execute computing programs. Data may be stored in the RAM 618, where the data may be accessed by the computer CPU 602 during execution. In one example configuration, the device 600 may include at least 128 MB of RAM, and 256 MB of flash memory.

The storage medium 622 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media may allow the device 600 to access computer-executable process steps, application programs and the like, stored on removable and non-removable memory media, to off-load data from the device 600 or to upload data onto the device 600. A computer program product, such as one utilizing a communication system may be tangibly embodied in storage medium 622, which may comprise a machine-readable storage medium.

In an example implementation of the disclosed technology, the mobile computing device computing system architecture 600 may include any number of hardware and/or software applications 221, 222 that are executed to facilitate any of the operations. In an example implementation, one or more I/O interfaces may facilitate communication between the mobile device computing system architecture 600 and one or more input/output devices. For example, a universal serial bus port, a serial port, a disk drive, a CD-ROM drive, and/or one or more user interface devices, such as a display, keyboard, keypad, mouse, control panel, touchscreen display, microphone, etc., may facilitate user interaction with the mobile device computing system architecture 600. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the mobile device computing system architecture 600 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, a proximity network, etc., for communication with external devices and/or systems. As desired, implementations of the disclosed technology may include the mobile device computing system architecture 600 with more or less of the components illustrated in FIG. 6.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, may be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that may direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method comprising:
associating a first layer stack with a plurality of application windows, the first layer stack being a logical attribute representing a dimensionless virtual display area, and each application window of the plurality of application windows associated with a unique surface having a position relative to the virtual display area and a size;
associating the first layer stack with a first logical display, the first logical display having a first logical resolution;
applying a first display projection to portions of one or more surfaces of the plurality of surfaces, the portions of the one or more surfaces each coinciding with a first region of the virtual display area, the first region corresponding to the first logical resolution of the first logical display;
responsive to applying the first display projection, rendering the portions of the one or more surfaces coinciding with the first region to generate a rendered first region; and
outputting at least part of the rendered first region for display at a first display device.

2. The method of claim 1 further comprising formatting the one or more surfaces based on the first logical resolution of the first logical display.

3. The method of claim 1, wherein the first display device has a first display resolution different from the first logical resolution, and wherein applying the first display projection scales the portions of the one or more surfaces to fit the first display resolution.

4. The method of claim 3, wherein the first display projection preserves an aspect ratio of the first region.

5. The method of claim 1 further comprising:
applying a second display projection to portions of one more surfaces coinciding with a second region of a second virtual display area represented by a second layer stack, the second region corresponding to a second logical resolution of a second logical display;
rendering the portions of the one or more surfaces coinciding with the second region to generate a rendered second region; and
outputting at least part of the rendered second region for display at a second display device.

6. The method of claim 5, wherein the first layer stack and the second layer stack are a same layer stack and the first region and the second region are a same region of a same virtual display area.

7. The method of claim 6, wherein the first display device has a first display resolution and density, and the second display device has a second display resolution and density different from the first display resolution and density.

8. The method of claim 5, wherein the first layer stack and the second layer stack are different layer stacks.

9. The method of claim 5, wherein the first layer stack and the second layer stack are a same layer stack and the first region and the second region are different regions of the same layer stack.

10. The method of claim 5, wherein:
the first layer stack and the second layer stack are a same layer stack;
the first logical display and the second logical display are a same logical display; and
the first region and the second region are substantially adjacent regions of the same virtual display area and the coinciding portions with the first region and the coinciding portions with the second region are jointly rendered.

11. The method of claim 8, wherein the first display device and the second display device are a same display device and the rendered first region and the rendered second region are output for display at the same display device.

12. A system comprising:
a first logical display having a first logical resolution, the first logical display associated with a first layer stack representing a dimensionless virtual display area;
a display combinator for rendering portions of surfaces coinciding with regions of the virtual display area, for display at a first display device;
at least one processor operatively coupled to the first display device;
at least one memory operatively coupled to the at least one processor and configured for storing data and instructions that, when executed by the at least one processor, cause the system to:
associate a first surface of an application window with the first logical display and assign the first surface to the first layer stack;
apply a first display projection to a portion of the first surface coinciding with a first region of the virtual display area, the first region corresponding to the first logical resolution of the first logical display;
render the portion of the first surface coinciding with the first region using the display combinator to generate a rendered first region; and
output at least part of the rendered first region for display at the first display device.

13. The system of claim 12, wherein the instructions, when executed by the at least one processor, further cause the system to format the portion of the first surface based on the first logical resolution of the first logical display.

14. The system of claim 12, wherein the instructions, when executed by the at least one processor, further cause the system to:
apply a second display projection to a portion of a second surface coinciding with a second region of a virtual display area represented by a second layer stack, the second region corresponding to a second logical resolution of a second logical display;
render the portion of the virtual display area coinciding with the second region; and
output at least part of the rendered second region for display at a second display device.

15. The method of claim 14, wherein:
the first layer stack and the second layer stack are a same layer stack;
the first region and the second region are a same region of a same virtual display area;
the first display device has a first display resolution and density; and
the second display device has a second display resolution and density different from the first display resolution and density.

16. The system of claim 14, wherein the first layer stack and the second layer stack are different layer stacks.

17. The system of claim 14, wherein the first layer stack and the second layer stack are a same layer stack and the first region and the second region are different regions of the same virtual display area.

18. The system of claim 14, wherein:
the first layer stack and the second layer stack are a same layer stack;
the first logical display and the second logical display are a same logical display; and
the first region and the second region are substantially adjacent regions of the same virtual display area and the coinciding portions with the first region and the coinciding portions with the second region are jointly rendered.

19. (canceled)

20. The computer-readable medium of claim 21, the method further comprising formatting the first surface based on the first logical resolution of the first logical display.

21. A non-transitory computer-readable medium containing instructions that, when executed by at least one processor in a system, cause the system to perform a method comprising:
associating a first layer stack with an application window, the first layer stack being a logical attribute representing a dimensionless virtual display area, and the application window associated with a unique surface having a position relative to the virtual display area and a size;
associating the first layer stack with a first logical display, the first logical display having a first logical resolution;
applying a first display projection to a portion of the surface coinciding with a first region of the virtual display area, the first region corresponding to the first logical resolution of the first logical display;
responsive to applying the first display projection, rendering the portions of surface coinciding with the first region to generate a rendered first region; and
outputting at least part of the rendered first region for display at a first display device.
